(19) United States
(12) Patent Application Publication
(10) Pub. No.: US 2020/0242259 A1
(43) Pub. Date: Jul. 30, 2020

(54) DATA COLLECTION CONSENT TOOLS

(71) Applicant: Google LLC, Mountain View, CA (US)

(72) Inventors: Varun Raj Chirravuri, New York, NY (US); Nikhil Singhal, New York, NY (US); Lorna T. Lim, Brooklyn, NY (US); Andres Gregoire, New York, NY (US); Ron Offer Yehoshua, Brooklyn, NY (US); Michael Gazzola, New York, NY (US); Vegard Johnsen, New York, NY (US)

(21) Appl. No.: 16/852,044

(22) Filed: Apr. 17, 2020

Related U.S. Application Data
(63) Continuation of application No. PCT/US2019/029968, filed on Apr. 30, 2019.
(60) Provisional application No. 62/667,995, filed on May 7, 2018.

(51) Int. Cl. G06F 21/60; H04W 12/02; G06F 21/62; G06Q 30/02

(52) U.S. Cl. CPC G06F 21/604; H04W 12/02; G06F 2221/2111; G06Q 30/0201; G06F 21/6263

(57) ABSTRACT

Methods, systems, apparatus, including computer programs encoded on a computer storage medium, for providing a publisher with a privacy control UI that enables the publisher to assign one privacy wall to each domain-purpose pair; determining that the publisher has created an additional privacy wall for a specific domain-purpose pair that has an existing privacy wall; in response to determining, restricting the specific domain-purpose pair to a single active privacy wall, including: in response to creation of the additional privacy wall: enabling only one of the existing privacy wall and the additional privacy wall to be in an active state; maintaining any privacy wall that is not in the active state in an inactive state; detecting a transition of a specific privacy wall from the inactive state to the active state; in response to detecting, transitioning a different privacy wall from the active state to the inactive state.

### CROSS-REFERENCE TO RELATED APPLICATIONS

This application is a continuation application of, and claims priority to, WIPO Patent Application No. PCT/US2019/029968, titled “DATA COLLECTION CONSENT TOOLS,” filed on Apr. 30, 2019, which application claims the benefit under 35 U.S.C. § 119(e) of U.S. Patent Application No. 62/667,995, titled “DATA COLLECTION CONSENT TOOLS,” filed May 7, 2018. The disclosure of the foregoing applications are incorporated herein by reference in their entirety for all purposes.

### FIELD

The present specification relates to privacy wall selection for electronic documents and electronic domains

### BACKGROUND

Digital content can be personalized to one or more users visiting webpages based on information related to the users.

### SUMMARY

Innovative aspects of the subject matter described in this specification may be embodied in methods that include the actions of providing a publisher with a privacy control user interface that includes one or more controls that enable the publisher to assign one privacy wall to each domain-purpose pair; determining that the publisher has created an additional privacy wall for a specific domain-purpose pair that already has an existing privacy wall; in response to determining that the publisher has created the additional privacy wall, restricting the specific domain-purpose pair to a single active privacy wall, including: in response to creation of the additional privacy wall: enabling only one of the existing privacy wall and the additional privacy wall to be in an active state at any given time; and maintaining any privacy wall that is not in the active state in an inactive state; detecting a transition of a specific privacy wall from the inactive state to the active state; and in response to detecting the transition of the specific privacy wall from the inactive state to the active state, transitioning a different privacy wall from the active state to the inactive state.

Other embodiments of these aspects include corresponding systems, apparatus, and computer programs, configured to perform the actions of the methods, encoded on computer storage devices.

These and other embodiments may each optionally include one or more of the following features. For instance, triggering display of a warning message in response to creation of the additional privacy wall while another privacy wall is in the active state; and setting the additional privacy wall to the inactive state when creation of the additional wall occurs while another privacy wall is in the active state. Providing a control that enables the publisher to create a vendor list for a specified purpose; monitoring a number of vendors added to the vendor list for the specified purpose; triggering display of a warning message when the publisher attempts to increase the number of vendors in the vendor list for the specified purpose beyond a specified maximum number of vendors. Providing the control that enables the publisher to create the vendor list includes providing one or more controls that enables the publisher to create a different vendor list for each of two or more different purposes. Detecting user interaction with a consent element presented in a specific privacy wall presented at a client device of a specific user; storing, in a cookie, consent data indicating that the specific user has consented to the use of user data for a given purpose corresponding to the domain-purpose pair; and enabling the user data of the specific user to be used for the given purpose while the consent of the specific user is valid. In response to detecting user interaction with the consent element, starting a consent validity timer for the domain-purpose pair; when the consent validity timer reaches a pre-specified value, resetting the consent for the domain-purpose pair; and after resetting the consent for the domain-purpose pair, requiring (i) presentation of the specific privacy wall or a different privacy wall, and (ii) a new interaction with the consent element prior to use of the user data of the specific user for the given purpose corresponding to the domain-purpose pair. Storing the consent data indicating that the specific user has consented to the use of user data in the cookie includes storing the consent data in the publisher's domain with a default naming convention that enables other entities that differ from the publisher to read the cookie. Storing, within the cookie, a list of third party identifiers and a corresponding consent identifier for each third party identified by the third party identifier, wherein the consent identifier specifies whether the specific user has consented to that third party using the user data of the specific user. Triggering presentation of a change consent control that is presented on a publisher's page for the publisher after the specific user has consented to the use of the user data by the publisher; detecting user interaction with the change consent control that enables the specific user to change their consent selection; detecting user interaction with a revoke consent control that revokes a prior consent to the use of the user data by the publisher; and updating the cookie to indicate that the specific user does not consent to the publisher using the user data. After storing the consent data in the cookie, determining that a vendor list of the publisher has been modified to add an additional vendor; in response to determining that the vendor list has been modified to add the additional vendor, triggering presentation of a new instance of a privacy wall that requests renewed consent from the specific user and informing the specific user of the additional vendor that was added to the vendor list. Detecting user interaction with a non-consent control indicating that the specific user does not consent to use of the user data by the additional vendor; and in response to detecting the user interaction with the non-consent control, updating the cookie to indicate that the specific user does not consent to the use of the user data for the domain-purpose pair corresponding to the vendor list.

The features further include triggering presentation of the specific privacy wall that includes both of an explore consent control and a purchase ad removal pass control, wherein user interaction with the explore consent control triggers presentation of data related to consent options and interaction with the purchase ad removal pass initiates a workflow that enables the specific user to obtain an ad free experience. Interaction with the explore consent control triggers presentation of a user interface that includes multiple different opt-in options for granting consent to use user data. The user interface lists of one or more purposes that are capable of using the user data and corresponding domains that utilize the one or more purposes, and wherein the user interface includes controls to selectively consent to the user data by one or more of the corresponding domains for each of the one or more purposes. Triggering presentation of the specific privacy wall is performed in response to detecting that the user device has a specified geographic location indicator. Storing the consent data in the cookie includes storing a consent record entry that lists a set of consented third parties that the specific user has consented to using the user data and a set of unconsented third parties that the specific user has not consented to using the user data. The cookie includes a counter value specifying how long it has been since the specific user provided consent. The cookie includes a set of vendors that are included in vendor lists for the set of consented third parties and a different set of vendors that are included in the vendor lists for the set of unconsented third parties. Receiving, from the client device, a request for a page provided by the publisher; inspecting the cookie in response to the request; determining, based on the inspection of the cookie, a current consent status of the specific user relative to use of the user data for at least one domain-purpose pair; and responding to the request based on the current consent status. Responding to the request based on the current consent status includes responding to the request by triggering presentation of the page in response to determining that the current consent status allows for the publisher to load the page without prompting the user for consent; and responding to the request by triggering presentation of the specific privacy wall instead of the page in response to determining that the current consent status does not allow for the publisher to load the page without prompting the user for consent. Determining a current consent status of the specific user includes triggering a script that invokes a script that inspects the cookie for the current consent status. Triggering the script includes triggering a script that determines whether the cookie exists for the specified user, a last refresh time for the cookie, and a geographic location of the client device. In response to determining that the last refresh time for the cookie is not within a specified period, refreshing the cookie with information about vendors that are included in a vendor list of the publisher. In response to determining that the vendors included in the vendor list of the publisher match the set of vendors identified in the cookie, refreshing the cookie and not requiring presentation of an update consent user interface. In response to determining that the vendors included in the vendor list of the publisher do not match the set of vendors identified in the cookie, refreshing the cookie and requiring presentation of an update consent user interface.

Particular implementations of the subject matter described in this specification can be implemented so as to realize one or more of the following advantages. For example, user privacy can be improved by enabling users to specify whether data related to the user is used for purposes of personalizing content that is delivered to the user. Additionally, publishers are able to ensure that users that visit their sites are able to specify whether data related to the user is used to personalize content that is delivered to the user. Users are provided the opportunity to specify which entities are allowed to utilize their personal data. Publishers are able to provide a convenient mechanism ensuring that users are provided the opportunity to modify how their personal data is used a specified times even after they have initially consented to the use of their personal data. Users are provided the opportunity to limit the use of their personal data when there is a change to the list of entities that are considered vendors of the publisher. In some situations, implementations of the subject matter provide for the efficient usage of computer resources by providing personalized digital content with electronic documents (webpages) to a subset of users. Selective allocation of computer resources to a selected population of users that is maximized for exposure of personalized digital content while preventing exposure of the personified digital content to an unselected population of users. That is, the computer resources are made efficient by limiting the exposure of the personalized digital content to a selected population of users. This avoids expending computing resources for transmission of the personalized digital content to the unselected population of users, with the computing resources being utilized efficiently in the transmission of the personalized digital content to the selected population of users. Furthermore, this reduces network congestion and increases network efficiency as a result of transmitting the personalized digital content to a subset of the population of users. Network bandwidth is conserved by transmitting the personalized digital content from the servers to a selected population of the computing devices as opposed to a larger set of computing devices.

The details of one or more embodiments of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 depicts a system for privacy wall selection for electronic documents and electronic domains.

FIGS. 2 and 4 illustrate consent user interfaces.

FIG. 3 illustrates a consent user interface including different opt-in options for granting consent to use user data.

FIGS. 5A, 5B, 5C, 6A, 6B and 6C illustrate workflows of a progression related to the consent user interface.

FIG. 7 is a flowchart of an example process for privacy wall selection for electronic documents and electronic domains.

FIG. 8 depicts an example computing system that may be used to implement the techniques described herein.

### DETAILED DESCRIPTION

This document describes methods, systems, and computer readable medium for privacy wall selection for electronic documents and electronic domains. Specifically, digital content publishers can create, configure, and deliver consent-messaging for their site/domain that queries users (e.g., site visitors) whether they would like to allow data sharing for personalized digital content delivery (e.g., digital advertisements) and measurement of such sharing. Additionally, the publishers are provided the ability to offer an alternate choice to users that do not consent to personalize digital content delivery—i) allow users to view non-personalized digital content or ii) pay a nominal fee to view pages of the domain without additional personalized content (e.g., advertisements). The system can further store the user's preference—whether to i) consent to data sharing for personalized digital content delivery or B) pay a nominal fee to become a “contributor” for non-personalized digital content. The system can automatically detect a user's state when available and not show consent messaging to users who have previously made a choice. For such users, the system can automatically show personalized digital content or show non personalized digital content. If the user is a contributor, the system can remove digital content from the electronic document prior to rendering.

In short, the system can provide a user facing user interface that includes a message that requires a user to actively choose to view a website that does not require users to consent to access the site; and provides an alternative using non-personalized digital content delivery, or become a contributor. The system utilizes a cookie to store, update, and manage user data-sharing consent; and an API for communication to preserve/represent user choice to determine which digital content (personalize or non-personalized) to provide for display. The system further creates and maintains vendor list(s) for user consent that includes a single, de-duped list of digital content providers used on a particular web page.

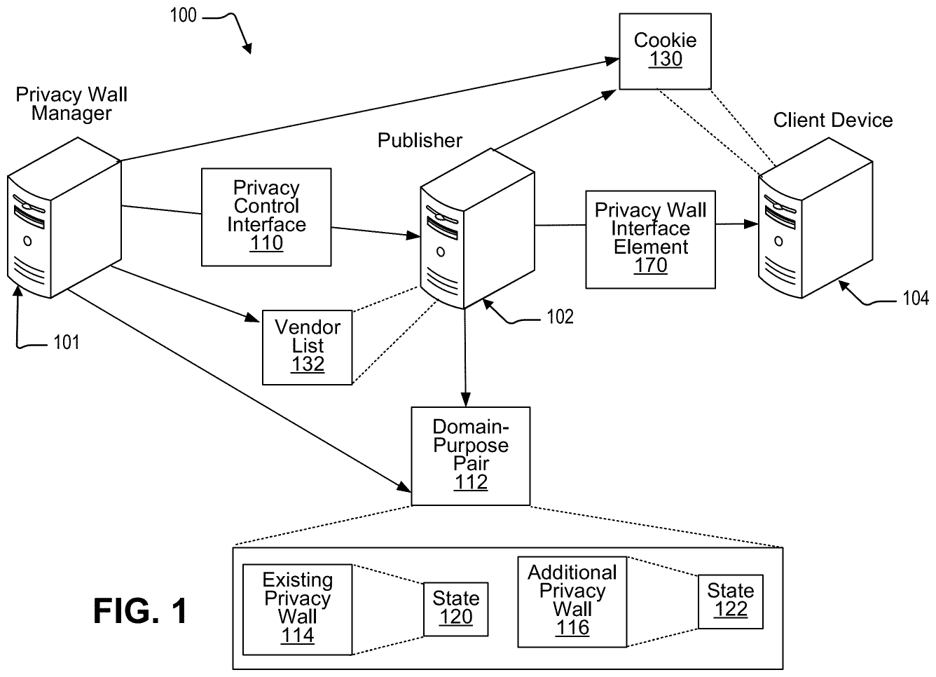

FIG. 1 depicts a system 100 for privacy wall selection for electronic documents and electronic domains. The system 100 includes a privacy wall manager 101, a publisher computing device 102, and a client computing device 104. The privacy wall manager 101 can be in communication with the publisher computing device 102 over one or more networks (not shown); and the publisher computing device 102 can be in communication with the client computing device 104 over one or more networks (not shown). In some examples, the privacy wall manager 101 and the publisher computing device 102 can each include one or more modules, and each can be respectively implemented as a combination of computing systems or in a same set of physical hardware.

The system 100 can create and manage (electronic) privacy walls of domains, and domain-purpose pairs, described further herein. The privacy walls can be associated with states, including an active state, a paused state, and a disabled state. In short, the active state of a domain-purpose pair allows electronic transmission of electronic content of a domain of a domain-purpose pair; an inactive (or paused) state indicates that nothing is provided on the underlying domain-purpose pair; and a disabled state indicates that the underlying domain may fail to comply with one or more required standards. As used throughout this document, the term purpose refers to the reason for which data is used, and the phrase domain-purpose pair specifies a combination of a specific online domain that can collect user data and a purpose for which that user data is potentially used. The system 100 provides that for each domain-purpose pair, there is at most a single active privacy wall that is active at a time.

In some implementations, the privacy wall manager 101 provides the publisher computing device 102 a privacy control user interface 110 that includes one or more controls that enable the publisher computing device 102 to assign one privacy wall to each domain purpose pair, e.g., the specific domain-purpose pair 112. The specific domain-purpose pair 112 can include an existing privacy wall 114 that includes a state 120. The publisher computing device 102 can create an additional privacy wall 116 for the specific domain-purpose pair 112 that includes a state 122. In some examples, the creation of the additional privacy wall 116 by the publisher computing device 102 can be created in the inactive (paused) state. In some examples, the publisher computing device 102 copies the existing privacy wall 112 to create the additional privacy wall 116 (and created in the inactive state).

The privacy wall manager 101 determines that the publisher computing device 102 has created the additional privacy wall 116 for the specific domain-purpose pair 112. The privacy wall manager 101, in response to determining that the publisher computing device 102 has created the additional privacy wall 116, can restrict the specific domain purpose pair 112 to a single active privacy wall. Specifically, the privacy wall manager 101, in response to the creation of the additional privacy wall 116, enables only one of the existing privacy wall 114 and the additional privacy wall 116 to be in an active state at any given time. For example, the privacy wall manager 101 enables the state 120 of the existing privacy wall 114 to be in the active state at a first time. Further, privacy wall manager 101 maintains the privacy wall that is not in the active state in an inactive state. For example, the privacy wall manger 101 enables the state 122 of the additional privacy wall 116 to be in an inactive state.

The privacy wall manager 101 can detect a transition of a specific privacy wall from the inactive state to the active state. For example, the privacy wall manager 101 can detect a transition of the state 122 of the additional privacy wall 116 from the inactive state to the active state. The privacy wall manager 101, in response to detecting the transition of the specific privacy wall from the inactive state to the active state, transitions a different privacy wall from the active state to the inactive state. For example, the privacy wall manager 101 transitions the state 120 of the existing privacy wall 114 from the active state to the inactive state.

In some examples, the privacy wall manager 101, in response to the creation of the additional privacy wall 116 while the state 120 of the of the existing privacy wall 114 is active, triggers display of a warning message at the publisher computing device 102. Furthermore, the privacy wall manager 101 sets the state 122 of the additional privacy wall 116 to an inactive state when the creation of the additional privacy wall 116 occurs while the state 120 of the existing privacy wall 114 is active.

In some examples, the privacy wall manager 101 provides a control to the publisher computing device 102 that enables the publisher computing device 102 to create a vendor list 132 for a specified purpose. For example, the vendor list 132 can be for the specific domain-purpose pair and/or the user accessing the specific domain. In some examples, the control enables the publisher computing device 102 to create a different vendor list 132 for each of two or more different purposes. The privacy wall manger 101 monitors the number of vendors added to the vendor list 132 for the specified purpose, and triggers display of a warning message at the publisher computing device 120 when the publisher computing device 120 attempts to increase the number of vendors in the vendor list 132 for the specified purpose beyond a specified maximum number of vendors. The term vendor can additionally be referred to as an ad technology provider (ATP).

In some examples, the publisher computing device 102 can create the vendor list 132 using web-property codes. Specifically, the publisher computing device 102 can add any number of web property codes and/or DoubleClick Ad Exchange (AdX), DoubleClick for Publishers (DFP), and/or Adsense network codes for the domain such that the vendor list 132 automatically populated. The warning message can further be provided when the publisher computing device 102 has set non-personalized digital content for a particular web property code that has been added. In some examples, the publisher computing device 102 can create the vendor list 132 using manual addition. That is, the publisher computing device 102 manual adds the vendors to the vendor list 132 on a per-vendor basis.

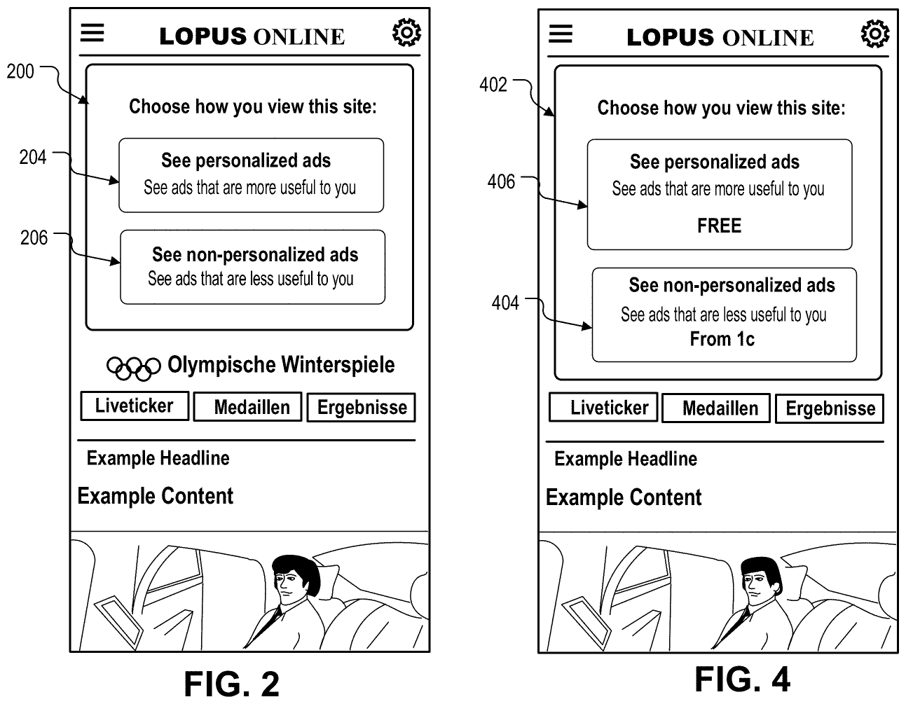

The publisher computing device 102 can provide a consent user interface 170 to the client computing device 104. The privacy wall manager 101 and/or the publisher computing device 102 can further detect user interaction with a consent element (of the consent user interface) presented in a specific privacy wall presented at the client computing device 104 of a specific user. As illustrated in FIG. 2, a consent element 200 is provided that can be presented on a graphical user interface (GUI) of the client computing device 104. The consent element 200 can include user interactable interface elements 204, 206 for providing or declining such consent. For example, the user can select the interface element 204 to provide consent to the use of user data for the given purpose corresponding to the domain-purpose pair. The privacy wall manger 101 can store, in a cookie 130, consent data that indicates that the specific user has consented to the use of user data for a given purpose corresponding to the domain-purpose pair. The privacy wall manager 101 can enable the user data of the specific user to be used for the given purpose while the consent of the specific use is valid.

In some examples, the publisher computing device 102 can create the vendor list 132 for display in the consent user interface 170. However, upon loading of the web page provided by the publisher computing device 102, the publisher computing device 102 can utilize the web property codes and IDs to call an advertising server and dynamically repopulate the vendor list 132. This is done in response to determining that a) the consent data of the cookie 130 matches the actual vendors that are being served and b) the vendor list 132 meets the required specifications. Thus, the privacy wall manager 101 can dynamically determine which vendors can have access to user consent data through various ad serving platforms on each web page rendered.

In some examples, the consent data of the cookie 130 is stored in the publisher's domain. For example, the cookie 130 is stored by the client computing device 104 and in the publisher's domain. The consent data of the cookie 130 can be stored using a default naming convention that enables entities other than the publisher computing device 102 to read the cookie 130. For example, other entities (not shown) that have access to the cookie 130 are able to read the cookie 130 given the default naming convention used with the cookie 130.

In some examples, the publisher computing device 102 stores, within the cookie 130, a list of third party identifiers and a corresponding consent identifier for each third party identified by the third party identifier. The consent identifier can specify whether the specific user has consented to that third party using the user data of the specific user. The cookie 130 can also store a consent date (or re-consent date) for the consent provided by the specific user for that third party.

In some examples, the privacy wall manager 101 and/or the publisher computing device 102 triggers presentation of a change consent control that is presented on electronic webpage provided by the publisher computing device 102 after the specific user has consented to the use of the user data by the publisher. That is, the publisher computing device 102, in response to a trigger form the privacy wall manager 101, provides a change consent control on the GUI of the client computing device 104. The publisher computing device 102 can detect user interaction with the change consent control that enables the specific user to change their consent selection, and/or detect user interaction with a revoke consent control that revokes a prior consent to the use of the user data by the publisher computing device 102. In other words, the user is able to change their consent status for any reason and on any visit to a participating website. In some cases, the change consent control is an interface element that can be an expandable notification presented on the webpage that when selected, expands to the original consent workflow. The publisher computing device 102 can update the cookie 130 to indicate that the specific user does not consent to the publisher computing device 102 using the user data.

In some examples, the privacy wall manager 101 and/or the publisher computing device 102, in response to detecting user interaction with the consent element, starts a consent validity timer for the domain-purpose pair. That is, the validity timer tracks an initialization of the consent given by the particular user with the consent element for the domain-purpose pair. When the consent validity timer reaches a pre-specified value (e.g., 1 month, 6, months, 12 months), the privacy wall manager 101 resets the consent for the domain-purpose pair. That is, the consent previously provided by the user for the user of the user data by the publisher computing device 102 is reset. After the consent for the domain-purpose pair is reset, the privacy wall manager 101 requires (i) presentation of the specific privacy wall or a different privacy wall and (ii) a new interaction with the consent element prior to use of the user data of the specific user for the given purpose corresponding to the domain-purpose pair. For example, the privacy wall manager 101 can require presentation of the existing privacy wall 114 or the additional privacy wall 116 based on the states 120 and 122, respectively. Additionally, the privacy wall manager 101 can require a new interaction with the consent element 200 prior to use of the user data for the specific user for the given purpose corresponding to the specific domain-purpose pair 112.

In some examples, after the publisher computing device 102 stores the consent data in the cookie 130, the privacy wall manager 101 determines that the vendor list 132 of the publisher computing device 102 has been modified to add an additional vendor. That is, the publisher computing device 102 adds an additional vendor to the vendor list 132. The privacy wall manager 101, in response to determining that the vendor list 132 has been modified to add the additional vendor, triggers presentation of a new instance of the privacy wall through the publisher computing device 102 that is presented on an electronic webpage of the publisher. The new instance of the privacy wall that requests renewed consent from the specific user, and further informs the specific user of the additional vendor that was added to the vendor list 132. In some examples, the new instance additionally includes a web link to an electronic document that displays the previous vendors of the vendor list 132—e.g., previously consented vendors.

In some examples, the privacy wall manager 101 and/or the publisher computing device 102 detects user interaction with a non-consent control indicating that the specific user does not consent to the user of the user data by the additional vendor. For example, after providing the new instance of the privacy wall requesting renewed consent from the specific user, the privacy wall 101 detects that the specific user does not provide such consent. The privacy wall manager 101, in response to detecting that the user interaction with the non-consent control, updates the cookie 130 to indicate that the specific user does not consent to the use of the user data for the specific domain-purpose pair 112 corresponding to the vendor list 132. Further, the cookie 130 can be updated to note that the specific user does not consent to the use of the user data for all of the vendors of the vendor list 132. In some examples, the publisher computing device 102 can update the cookie 130 to indicate that the specific user does not consent to the use of the user data for the specific domain-purpose pair 112 corresponding to the vendor list 132. In the illustrated example of FIG. 2, the user can select the interface element 206 to provide non-consent to the use of user data for the given purpose corresponding to the domain-purpose pair 112.

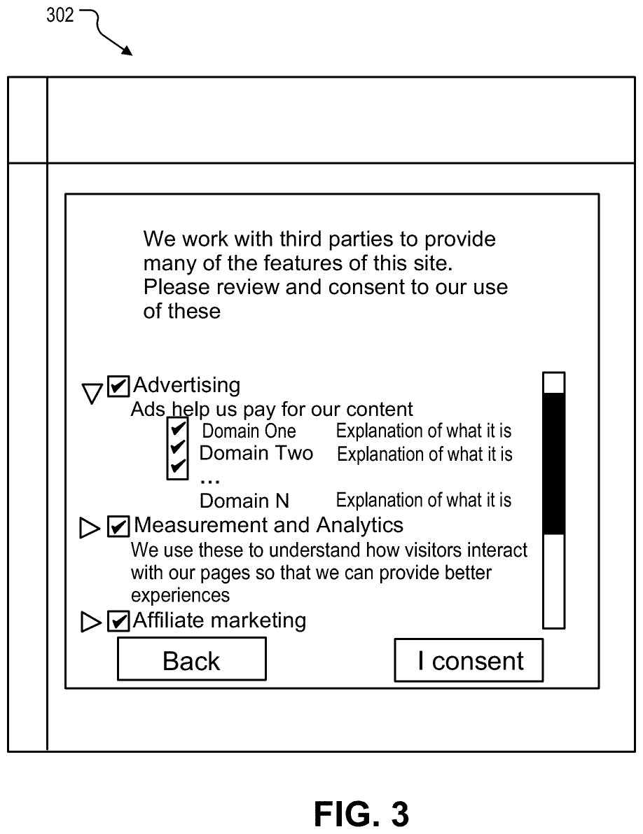

In some examples, the change consent control that is presented on the electronic webpage provided by the publisher computing device 102 includes an explore consent control interface element. For example, referring to FIG. 2, the interface element 204 can provide the explore consent control interface. To that end, when the interface element 204 is selected by the specific user, presentation of data is triggered that is related to consent options. For example, referring to FIG. 3, the selection of the interface element 204 triggers presentation of a user interface 302 (overlay) that includes multiple different opt-in options for granting consent to use user data. The user interface 302 includes a listing of purposes that are capable of using the user data and corresponding domains that utilize the one or more purposes. For example, as illustrated in FIG. 3, the listing of purposes includes “advertising,” “measurement and analytics,” and “affiliate marketing;” however, other purposes are possible. The user interface 302 further includes controls to selectively consent to the use of the user data by the one or more of the corresponding domains for each of the one or more purpose. For example, the user interface 302 includes checkboxes indicating consent (checked) and/or no consent (not checked).

In some examples, the change consent control that is presented on the electronic webpage provided by the publisher computing device 102 includes a purchase ad removal pass control. For example, referring to FIG. 4, a change consent control interface 402 is displayed that includes an user interactable user interface element 404 that is related to the purchase ad removal pass control. To that end, when the interface element 404 is selected by the specific user, a workflow is initiated that enables the specific user to obtain an ad free experience. The change consent control interface 402 can further include an user interactable user interface element 406 similar to the interface element 204 of FIG. 2—that is, the user can select the interface element 406 to provide consent to the use of user data for the given purpose corresponding to the domain-purpose pair 112.

In some examples, the change consent control is presented on the electronic webpage provided by the publisher computing device 102 in response to detecting that the user computing device 104 has a specified geographic location indicator. For example, the privacy wall manager 102 can determine the geographic location indicator of the user computing device 104, and based on the geographic location of the geographic location indictor, present the change consent control, or present a particular (of many) change consent control specific for the geographic location.

In some examples, the publisher computing device 102, when storing the consent data in the cookie 130, further stores a record entry that lists a set of consented third parties that the specific user has consented to using the user data and a set of unconsented third parties that the specific user has not consented to using the user data. In some examples, the publisher computing device 102, when storing the consent data in the cookie 130, further stores a counter value specifying how long it has been since the specific user provided consent. For example, the counter value corresponds to the validity timer that tracks an initialization of the consent given by the particular user with the consent element for the domain-purpose pair. In some examples, the publisher computing device 102, when storing the consent data in the cookie 130, further stores a listing of the set of vendors that are included in the vendor list 132 for the set of consented third parties and a different set of vendors that are included in the vendor list 132 for the set of unconsented third parties.

In some examples, after storing the cookie 130, the publisher computing device 102 can receive a request for the electronic webpage that is provided by the publisher computing device 102. The publisher computing device 102 can access the cookie 130 from the client computing device 104, and inspect the cookie 130 in response to the request for the electronic webpage. The publisher computing device 102 can determine, based on the inspection of the cookie 130, a current consent status of the specific user relative to the use of the user data for at least one domain-purpose pair. For example, the cookie 130 can indicate that the publisher computing device 102 is able to load the electronic webpage, or indicate that the publisher computing device 102 is not able to load the electronic webpage. To that end, the publisher computing device 102 responds to the request based on the current consent status. That is, in some examples, the publisher computing device 102 can respond to the request by triggering presentation of the web page in response to determining that the current consent status allows for the publisher computing device 102 to load the web page without prompting the user for consent. Additionally, in some examples, the publisher computing device 102 can respond to the request by triggering presentation of the specific privacy wall instead of the web page in response to determining that the current consent status does not allow for the publisher computing device 102 to load the web page without prompting the user for consent. For example, if the specific user visits the webpage after making the consent decision, the current consent status of the cookie 130 is only called once.

In some examples, the publisher computing device 102 determines the current consent status of the specific user by triggering a script that invokes a script that inspects the cookie 130 for the current consent status. For example, triggering the script can include determining whether then cookie 130 exists for the specific user, a last refresh time for the cookie 130, and a geographic location of the client computing device 104. In some examples, the script is invoked only when the cookie 130 exists for the specific user and the last refresh time for the cookie 130 is less than a threshold time (e.g., 1 day). When the last refresh time of the cookie 130 is greater than the threshold time (not within a specified period), the publisher computing device 102 can refresh the cookie 130 with information about vendors that are included in the vendor list 132 of the publisher computing device 104.

In some examples, the publisher computing device 102 can determine, in response to inspecting the cookie 130, determining that the vendors included in the vendor list 132 match the set of vendors identified in the cookie 130. When the vendors included in the vendor list 132 match the set of vendors identified in the cookie 130, the publisher computing device 102 does not require presentation of an update consent user interface. In some cases, the publisher computing device 102 refreshes the cookie 130 and requires presentation of an update consent user interface.

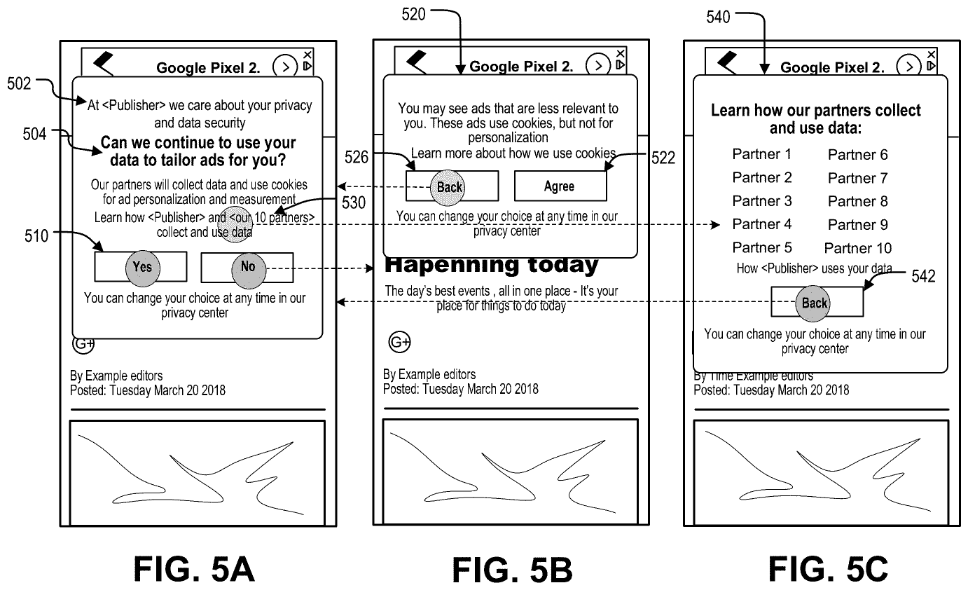

FIGS. 5A-5C illustrates a workflow of a progression related to the consent user interface. Specifically, FIG. 5A illustrates the consent user interface 502 including text 504 describing the use of user data for the given purpose corresponding to the domain-purpose pair 112, and further includes user interactable interface element 510 for providing consent, and user interactable interface element 512 for declining consent. The user can select the interface element 510 to provide consent to the use of user data for the given purpose corresponding to the domain-purpose pair 112. Further, the user can select the interface element 512 to decline consent to the user of user data for the given purpose corresponding to the domain-purpose pair 112. In response to declining consent, an updated consent user interface 520 is provided that includes interface element 522 for consenting to use of non-personalization of digital content to be provided (e.g., on the webpage of the publisher computing device 102). The user interface 520 further includes an interface element 526 for transitioning back to the user interface 502 of FIG. 5A Further, the user interface 502 of FIG. 5A can further a link 530, that when selected, provides the user interface 540 of FIG. 5C. The user interface 540 includes a listing of vendors (e.g., of the vendor list 132) for the domain-purpose pair 112. The user interface 540 further includes an interface element 542 for transitioning back to the user interface 502 of FIG. 5A.

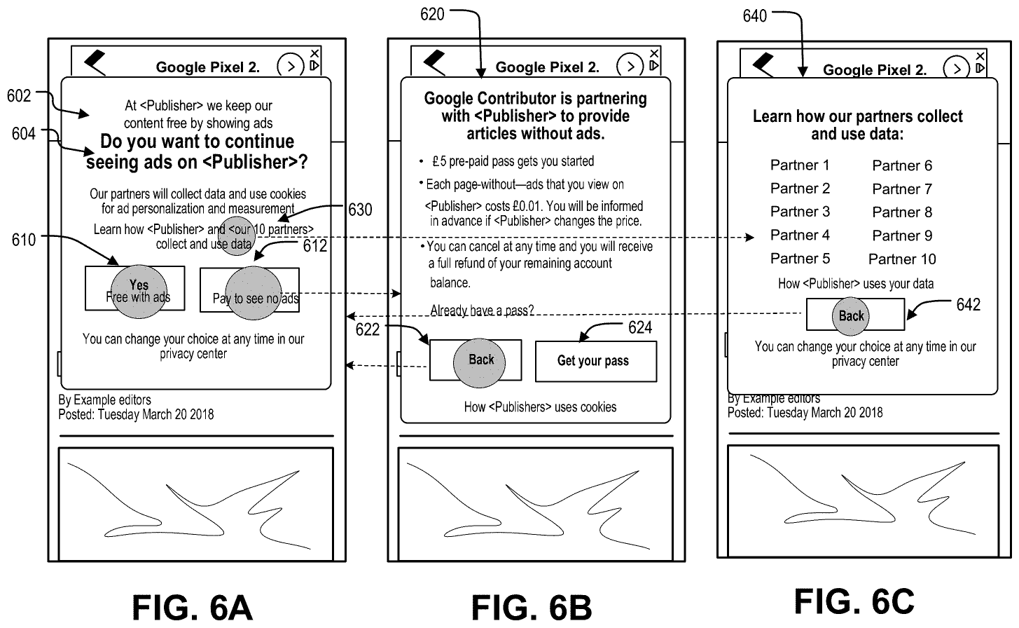

FIGS. 6A-6C illustrate a workflow of a further progression related consent user interface. Specifically, FIG. 6A illustrates the consent user interface 602 including text 604 describing the use of user data for the given purpose corresponding to the domain-purpose pair 112, and further includes user interactable interface element 610 for providing consent, and user interactable interface element 612 for declining consent. The user can select the interface element 610 to provide consent to the use of user data for the given purpose corresponding to the domain-purpose pair 112. Further, the user can select the interface element 612 to decline consent to the user of user data for the given purpose corresponding to the domain-purpose pair 112. In response to declining consent, an updated consent user interface 620 is provided that includes interface element 624 for purchasing an ad removal pass. The user interface 620 further includes an interface element 622 for transitioning back to the user interface 602 of FIG. 6A Further, the user interface 602 of FIG. 6A can further include a link 630, that when selected, provides the user interface 640 of FIG. 6C. The user interface 640 includes a listing of vendors (e.g., of the vendor list 132) for the domain-purpose pair 112. The user interface 650 further includes an interface element 642 for transmitting back to the user interface 602 of FIG. 6A.

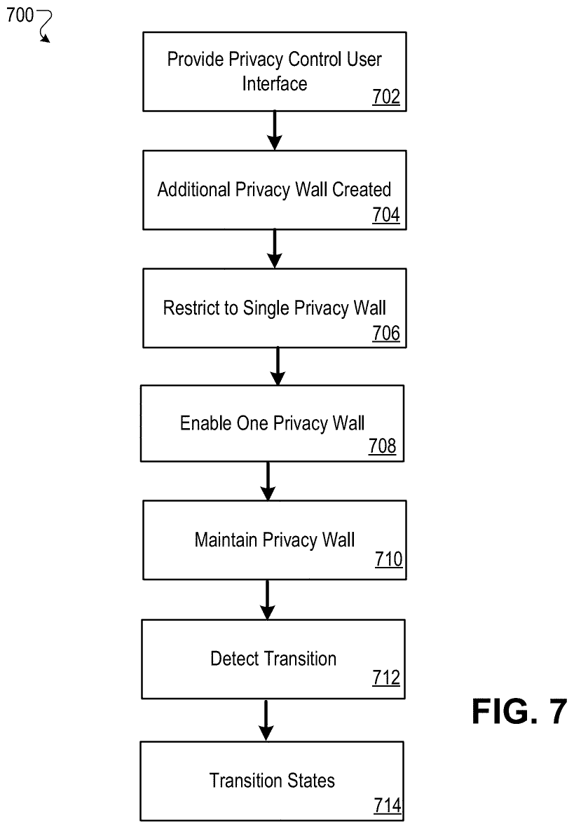

FIG. 7 illustrates an example process 700 for privacy wall selection for electronic documents and electronic domains. The process 700 can be performed, for example, by the system 100, or another data processing apparatus. The process 700 can also be implemented as instructions stored on a computer storage medium, and execution of the instructions by one or more data processing apparatus cause the one or more data processing apparatus to perform some or all of the operations of the process 700.

The privacy wall manager 101 provides the publisher computing device 102 a privacy control user interface 110 that includes one or more controls that enable the publisher computing device 102 to assign one privacy wall to each domain purpose pair (702). The privacy wall manager 101 determines that the publisher computing device 102 has created the additional privacy wall 116 for the specific domain-purpose pair 112 (704). The privacy wall manager 101, in response to determining that the publisher computing device 102 has created the additional privacy wall 116, restricts the specific domain purpose pair 112 to a single active privacy wall (706). The privacy wall manager 101, in response to the creation of the additional privacy wall 116, enables only one of the existing privacy wall 114 and the additional privacy wall 116 to be in an active state at any given time (708). The privacy wall manager 101 maintains the privacy wall that is not in the active state in an inactive state (710). The privacy wall manager 101 can detect a transition of a specific privacy wall from the inactive state to the active state (712). The privacy wall manager 101, in response to detecting the transition of the specific privacy wall form the inactive state to the active state, transitions a different privacy wall from the active state to the inactive state (714).

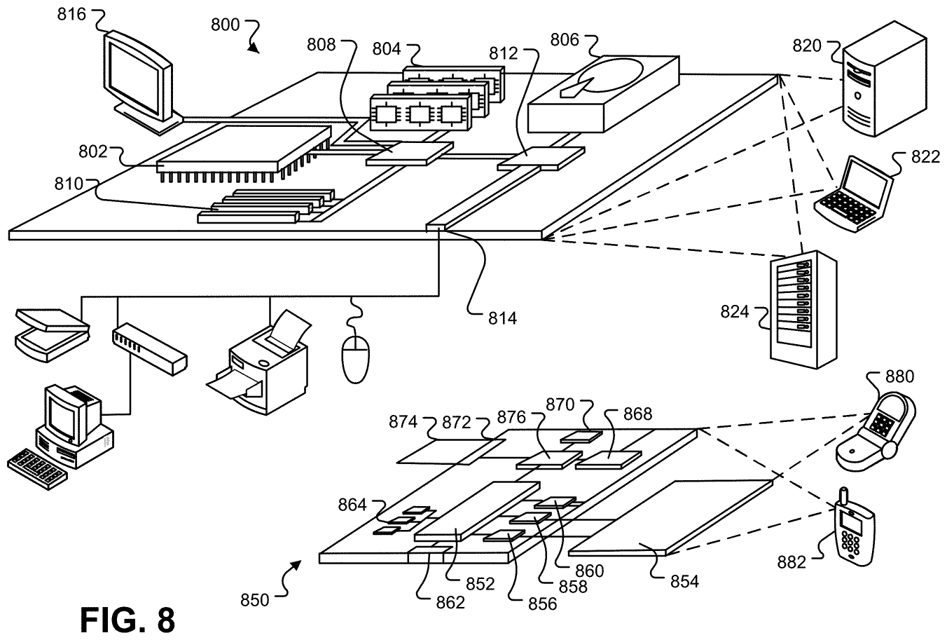

FIG. 8 shows an example of a generic computer device 800 and a generic mobile computer device 850, which may be used with the techniques described here. Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 may process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier is a computer- or machine-readable medium, such as the memory 804, the storage device 806, or a memory on processor 802.

The high speed controller 808 manages bandwidth-intensive operations for the computing device 800, while the low speed controller 812 manages lower bandwidth-intensive operations. Such allocation of functions is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 may execute instructions within the computing device 840, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 848 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provide in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 may be implemented as one or more of a computer-readable medium or media, a volatile memory unit or units, or a non-volatile memory unit or units. Expansion memory 854 may also be provided and connected to device 850 through expansion interface 852, which may include, for example, a SIMM (Single In Line Memory Module) card interface. Such expansion memory 854 may provide extra storage space for device 850, or may also store applications or other information for device 850. Specifically, expansion memory 854 may include instructions to carry out or supplement the processes described above, and may include secure information also. Thus, for example, expansion memory 854 may be provide as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 854, memory on processor 852, or a propagated signal that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, WiFi, or other such transceiver (not shown). In addition, GPS (Global Positioning System) receiver module 850 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smartphone 882, personal digital assistant, or other similar mobile device.

Various implementations of the systems and techniques described here may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

While this disclosure includes some specifics, these should not be construed as limitations on the scope of the disclosure or of what may be claimed, but rather as descriptions of features of example implementations of the disclosure. Certain features that are described in this disclosure in the context of separate implementations can also be provided in combination in a single implementation. Conversely, various features that are described in the context of a single implementation can also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the present disclosure have been described. Other implementations are within the scope of the following claims. For example, the actions recited in the claims can be performed in a different order and still achieve desirable results. A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

1. A method, comprising
providing, by one or more processors, a publisher with a privacy control user interface that includes one or more controls that enable the publisher to assign one privacy wall to each domain-purpose pair;
determining, by the one or more processors, that the publisher has created an additional privacy wall for a specific domain-purpose pair that already has an existing privacy wall;
in response to determining that the publisher has created the additional privacy wall, restricting the specific domain-purpose pair to a single active privacy wall, including:
in response to creation of the additional privacy wall:
enabling, by the one or more processors, only one of the existing privacy wall and the additional privacy wall to be in an active state at any given time; and
maintaining, by the one or more processors, any privacy wall that is not in the active state in an inactive state;
detecting a transition of a specific privacy wall from the inactive state to the active state;
in response to detecting the transition of the specific privacy wall from the inactive state to the active state, transitioning a different privacy wall from the active state to the inactive state.

2. The method of claim 1, further comprising:
triggering display of a warning message in response to creation of the additional privacy wall while another privacy wall is in the active state; and
setting the additional privacy wall to the inactive state when creation of the additional wall occurs while another privacy wall is in the active state.

3. The method of claim 1, further comprising:
providing a control that enables the publisher to create a vendor list for a specified purpose;
monitoring a number of vendors added to the vendor list for the specified purpose;
triggering display of a warning message when the publisher attempts to increase the number of vendors in the vendor list for the specified purpose beyond a specified maximum number of vendors.

4. The method of claim 3, wherein providing the control that enables the publisher to create the vendor list comprises providing one or more controls that enables the publisher to create a different vendor list for each of two or more different purposes.

5. The method of claim 1, further comprising:
detecting user interaction with a consent element presented in a specific privacy wall presented at a client device of a specific user;
storing, in a cookie, consent data indicating that the specific user has consented to the use of user data for a given purpose corresponding to the domain-purpose pair; and
enabling the user data of the specific user to be used for the given purpose while the consent of the specific user is valid.

6. The method of claim 5, comprising:
in response to detecting user interaction with the consent element, starting a consent validity timer for the domain-purpose pair;
when the consent validity timer reaches a pre-specified value, resetting the consent for the domain-purpose pair; and
after resetting the consent for the domain-purpose pair, requiring (i) presentation of the specific privacy wall or a different privacy wall, and (ii) a new interaction with the consent element prior to use of the user data of the specific user for the given purpose corresponding to the domain-purpose pair.

7. The method of claim 6, wherein storing the consent data indicating that the specific user has consented to the use of user data in the cookie comprises storing the consent data in the publisher's domain with a default naming convention that enables other entities that differ from the publisher to read the cookie.

8. The method of any of claim 5, further comprising storing, within the cookie, a list of third party identifiers and a corresponding consent identifier for each third party identified by the third party identifier, wherein the consent identifier specifies whether the specific user has consented to that third party using the user data of the specific user.

9. The method of claim 8, further comprising:
triggering presentation of a change consent control that is presented on a publisher's page for the publisher after the specific user has consented to the use of the user data by the publisher;
detecting user interaction with the change consent control that enables the specific user to change their consent selection;
detecting user interaction with a revoke consent control that revokes a prior consent to the use of the user data by the publisher; and
updating the cookie to indicate that the specific user does not consent to the publisher using the user data.

10. The method of claim 5, comprising:
after storing the consent data in the cookie, determining that a vendor list of the publisher has been modified to add an additional vendor;
in response to determining that the vendor list has been modified to add the additional vendor, triggering presentation of a new instance of a privacy wall that requests renewed consent from the specific user and informing the specific user of the additional vendor that was added to the vendor list.

11. The method of claim 5, further comprising:
detecting user interaction with a non-consent control indicating that the specific user does not consent to use of the user data by the additional vendor; and
in response to detecting the user interaction with the non-consent control, updating the cookie to indicate that the specific user does not consent to the use of the user data for the domain-purpose pair corresponding to the vendor list.

12. A system, comprising:
one or more memory devices; and
one or more processors connected to the one or more memory devices, the one or more processors configured to execute instructions stored in the one or more memory devices, wherein execution of the instructions cause the one or more processors to perform operations comprising:
providing a publisher with a privacy control user interface that includes one or more controls that enable the publisher to assign one privacy wall to each domain-purpose pair;
determining that the publisher has created an additional privacy wall for a specific domain-purpose pair that already has an existing privacy wall;
in response to determining that the publisher has created the additional privacy wall, restricting the specific domain-purpose pair to a single active privacy wall, including:
in response to creation of the additional privacy wall:
enabling only one of the existing privacy wall and the additional privacy wall to be in an active state at any given time; and
maintaining any privacy wall that is not in the active state in an inactive state;
detecting a transition of a specific privacy wall from the inactive state to the active state;
in response to detecting the transition of the specific privacy wall from the inactive state to the active state, transitioning a different privacy wall from the active state to the inactive state.

13. The system of claim 12, wherein the instructions cause the one or more processors to perform operations further comprising:
triggering display of a warning message in response to creation of the additional privacy wall while another privacy wall is in the active state; and
setting the additional privacy wall to the inactive state when creation of the additional wall occurs while another privacy wall is in the active state.

14. The system of claim 12, wherein the instructions cause the one or more processors to perform operations further comprising:
providing a control that enables the publisher to create a vendor list for a specified purpose;
monitoring a number of vendors added to the vendor list for the specified purpose;
triggering display of a warning message when the publisher attempts to increase the number of vendors in the vendor list for the specified purpose beyond a specified maximum number of vendors.

15. The system of claim 14, wherein providing the control that enables the publisher to create the vendor list comprises providing one or more controls that enables the publisher to create a different vendor list for each of two or more different purposes.

16. The system of claim 12, wherein the instructions cause the one or more processors to perform operations further comprising:
detecting user interaction with a consent element presented in a specific privacy wall presented at a client device of a specific user;
storing, in a cookie, consent data indicating that the specific user has consented to the use of user data for a given purpose corresponding to the domain-purpose pair; and
enabling the user data of the specific user to be used for the given purpose while the consent of the specific user is valid.

17. The system of claim 16, wherein the instructions cause the one or more processors to perform operations further comprising:
in response to detecting user interaction with the consent element, starting a consent validity timer for the domain-purpose pair;
when the consent validity timer reaches a pre-specified value, resetting the consent for the domain-purpose pair; and
after resetting the consent for the domain-purpose pair, requiring (i) presentation of the specific privacy wall or a different privacy wall, and (ii) a new interaction with the consent element prior to use of the user data of the specific user for the given purpose corresponding to the domain-purpose pair.

18. The system of claim 17, wherein storing the consent data indicating that the specific user has consented to the use of user data in the cookie comprises storing the consent data in the publisher's domain with a default naming convention that enables other entities that differ from the publisher to read the cookie.

19. The system of any of claim 16, wherein the instructions cause the one or more processors to perform operations further comprising storing, within the cookie, a list of third party identifiers and a corresponding consent identifier for each third party identified by the third party identifier, wherein the consent identifier specifies whether the specific user has consented to that third party using the user data of the specific user.

20. The system of claim 19, wherein the instructions cause the one or more processors to perform operations further comprising:
triggering presentation of a change consent control that is presented on a publisher's page for the publisher after the specific user has consented to the use of the user data by the publisher;
detecting user interaction with the change consent control that enables the specific user to change their consent selection;
detecting user interaction with a revoke consent control that revokes a prior consent to the use of the user data by the publisher; and
updating the cookie to indicate that the specific user does not consent to the publisher using the user data.

21. The system of claim 16, wherein the instructions cause the one or more processors to perform operations further comprising:
after storing the consent data in the cookie, determining that a vendor list of the publisher has been modified to add an additional vendor;
in response to determining that the vendor list has been modified to add the additional vendor, triggering presentation of a new instance of a privacy wall that requests renewed consent from the specific user and informing the specific user of the additional vendor that was added to the vendor list.

22. The system of claim 16, wherein the instructions cause the one or more processors to perform operations further comprising:
detecting user interaction with a non-consent control indicating that the specific user does not consent to use of the user data by the additional vendor; and
in response to detecting the user interaction with the non-consent control, updating the cookie to indicate that the specific user does not consent to the use of the user data for the domain-purpose pair corresponding to the vendor list.
